(19) United States
(12) Patent Application Publication
(10) Pub. No.: US 2022/0060824 A1
(43) Pub. Date: Feb. 24, 2022

(54) An Audio Capturing Arrangement

(71) Applicant: Nokia Technologies Oy, Espoo (FI)

(72) Inventors: Jussi VIROLAINEN, Espoo (FI); Juha VILKAMO, Helsinki (FI); Kai HAVUKAINEN, Lempaala (FI); Mikko TAMMI, Tampere (FI); Toni MAKINEN, Pirkkala (FI); Juha OJANPERA, Nokia (FI)

(21) Appl. No.: 17/417,860

(22) PCT Filed: Jan. 2, 2020
(86) PCT No.: PCT/FI2020/050001

§ 371 Date: Jun. 24, 2021

(30) Foreign Application Priority Data
Jan. 4, 2019 (GB) 1900112.2

(51) Int. Cl. H04R 3/00; G10L 19/008

(52) U.S. Cl. CPC H04R 3/005; G10L 19/008

(57) ABSTRACT

According to an example embodiment, a method for processing two or more microphone signals is provided. The method includes deriving a first captured audio signal having one or more channels based on the two or more microphone signals received from respective two or more microphones in accordance with capture control data that identifies at least one characteristic for derivation of the first captured audio signal; storing at least part of the capture control data and intermediate audio data derived based on the two or more received microphone signals; deriving modified capture control data as a combination of the stored capture control data and user-definable post-capture control data that identifies at least one characteristic for derivation of a second captured audio signal; and deriving the second captured audio signal having one or more channels based on said intermediate audio data in accordance with the modified capture control data.

### TECHNICAL FIELD

The example and non-limiting embodiments of the present invention relate to capturing of audio signals.

### BACKGROUND

Already for many years mobile devices such as mobile phones and tablet computers have been provided with a camera and a microphone arrangement that enable the user of the device to capture audio and video. With the development of microphone technologies and with increase in processing power and storage capacity available in mobile device, providing such mobile devices with multi-microphone arrangements that enable capturing multi-channel audio is becoming increasingly common, which in turn e.g. enables usage of the mobile device for recoding high-quality spatial audio. Typically, spatial audio (or multi-channel audio in general) is captured together with video, while multi-channel audio can be quite obviously recorded as a stand-alone media without accompanying video.

Typically, the process of capturing a multi-channel audio signal using the mobile device comprises operating a microphone array to capture a plurality of microphone signals and processing the captured microphone signals into a recorded multi-channel audio signal for further processing in the mobile device, for storage in the mobile device and/or for transmission to one or more other devices. FIG. 1 illustrates a block diagram of an audio capturing arrangement 100 according to an example. Therein, an audio processor 102 receives capture control data and a plurality of microphone signals and derives a captured audio signal on basis of the microphone signals in accordance with the capture control data. The plurality of microphone signals comprise respective (monophonic) digital audio signals recorded by respective one or more microphones, e.g. from microphones of an microphone array of the mobile device.

The audio processor 102 may enable a plurality of audio processing functions, whereas application of the audio processing functions available therein may be controlled via the capture control data. Non-limiting examples of such audio processing functions that may be applied by the audio processor 102 to the microphone signals or to one or more signals derived from the microphone signals include the following:
audio signal level adjustment (e.g. automatic gain control),
audio equalization,
dynamic range compression,
audio enhancement processing, such as wind noise removal,
audio focusing (e.g. “audio zooming” to emphasize a subset of an audio scene represented by the captured microphone signals),
modification of direction of front orientation (e.g. modification of orientation with respect to the audio scene represented by the captured microphone signals),
audio encoding.

The capture control data may further define general audio characteristics pertaining to the received microphone signals (i.e. input audio) and/or to captured audio signal (i.e. output audio), such as the number of input channels, the number of output channels, the sampling rate of the audio, the sample resolution of the audio (e.g. the number of bits per audio sample), the applied (output) audio format (e.g. binaural, loudspeaker channels according to a specified channel configuration, parametric audio, Ambisonics), etc. In addition to the general audio characteristics (of the input and/or output audio), the capture control data may define which of the audio processing functions available in the audio processor 102 are (to be) applied and, if applicable, respective audio processing parameters for controlling application of the respective audio processing function. Hence, the capture control data identifies at least one (audio) characteristic for derivation of the captured audio signal.

The capture control data may comprise definitions originating from preselection made by the user of the mobile device (and stored in a memory of the mobile device) prior to an audio capturing session, definitions originating from automated selection made by the mobile device and/or definitions originating from user input received upon initiation or during the audio capturing session. The capture control data, and hence the corresponding characteristics of operation of the audio processor 102, may remain unchanged throughout the audio capturing session. On the other hand, at least some aspects of the capture control data, and hence the corresponding characteristics of operation of the audio processor 102, may vary or be varied during the audio capturing session. Such variations may include enabling or disabling a certain audio processing function during the audio capturing session or changing characteristics of a certain audio processing function during the audio capturing session, either automatically under control of the mobile device or in response to user input received during the audio capturing session. The user input may include direct user input that directly addresses one or more audio characteristics of the audio capturing session and/or indirect user input that results from user adjusting a related procedure in the mobile device, e.g. changes video zooming settings applied for a concurrent video capturing session.

Consequently, the outcome of the audio capturing session carried out along the lines described above results in the captured audio signal that may be subsequently accessed by a user of the mobile device applying the audio capturing arrangement 100 or by a user of another device. The resulting captured audio signal reflects the selections made (with respect to application and characteristics of the audio processing functions available in the audio processor 102) upon deriving the captured audio signal.

In a typical usage scenario, at the time of capture the user of the mobile device at the same time also directly listens to the real audio scene he or she is capturing by the mobile device, and hence no ‘monitoring’ of the captured audio signal takes place during the audio capturing session. Consequently, the user may subsequently find the selections made upon deriving the captured audio signal non-optimal and/or another user may have different preferences with respect to selections that control operation of the audio processing functions available in the audio processor 102. However, some of the audio processing functions that have been applied in the underlying audio capturing session may have an effect that cannot be reversed (or ‘undone’) or reversing (or ‘undoing’) the respective audio processing function may result in compromised audio quality and/or excessive computation. Moreover, some of the audio processing functions that are available in the audio processor 102 but that were not applied upon deriving the captured audio signal cannot be necessarily applied for the captured audio signal or their application may result in comprised audio quality or excessive computation.

### SUMMARY

According to an example embodiment, a method for processing two or more microphone signals is provided, the method comprising: deriving a first captured audio signal having one or more channels based on the two or more microphone signals received from respective two or more microphones in accordance with capture control data that identifies at least one characteristic for derivation of the first captured audio signal; storing at least part of the capture control data and intermediate audio data derived based on the two or more received microphone signals; deriving modified capture control data as a combination of the stored capture control data and user-definable post-capture control data that identifies at least one characteristic for derivation of a second captured audio signal; and deriving the second captured audio signal having one or more channels based on said intermediate audio data in accordance with the modified capture control data.

According to another example, a method for processing two or more microphone signals is provided, the method comprising: deriving a first captured audio signal having one or more channels based on the two or more microphone signals received from respective two or more microphones in accordance with capture control data that identifies at least one characteristic for derivation of the first captured audio signal; and storing at least part of the capture control data and intermediate audio data derived based on the two or more received microphone signals to enable derivation of a second captured audio signal having one or more channels based on the intermediate audio data in accordance with at least part of the stored capture control data.

According to another example embodiment, a method for processing two or more microphone signals is provided, the method comprising: obtaining a first captured audio signal having one or more channels derived on basis of said two or more microphone signals in dependence of capture control data that identifies at least one characteristic for derivation of the first captured audio signal; obtaining at least part of said capture control data and intermediate audio data derived on basis of said two or more microphone signals; obtaining at least part of said capture control data and intermediate audio data derived on basis of said two or more microphone signals; and deriving the second captured audio signal having one or more channels based on said intermediate audio data in accordance with the modified capture control data.

According to another example embodiment, a system for processing two or more microphone signals is provided, the system comprising: a means for deriving a first captured audio signal having one or more channels based on the two or more microphone signals received from respective two or more microphones in accordance with capture control data that identifies at least one characteristic for derivation of the first captured audio signal; a means for storing at least part of the capture control data and intermediate audio data derived based on the two or more received microphone signals; a means for deriving modified capture control data as a combination of the stored capture control data and user-definable post-capture control data that identifies at least one characteristic for derivation of a second captured audio signal; and a means for deriving the second captured audio signal having one or more channels based on said intermediate audio data in accordance with the modified capture control data.

According to another example embodiment, an apparatus for processing two or more microphone signals is provided, the apparatus comprising: a means for deriving a first captured audio signal having one or more channels based on the two or more microphone signals received from respective two or more microphones in accordance with capture control data that identifies at least one characteristic for derivation of the first captured audio signal; a means for storing at least part of the capture control data and intermediate audio data derived based on the two or more received microphone signals; a means for deriving modified capture control data as a combination of the stored capture control data and user-definable post-capture control data that identifies at least one characteristic for derivation of a second captured audio signal; and a means for deriving the second captured audio signal having one or more channels based on said intermediate audio data in accordance with the modified capture control data.

According to another example embodiment, an apparatus for processing two or more microphone signals is provided, the apparatus comprising: a means for deriving a first captured audio signal having one or more channels based on the two or more microphone signals received from respective two or more microphones in accordance with capture control data that identifies at least one characteristic for derivation of the first captured audio signal; and a means for storing at least part of the capture control data and intermediate audio data derived based on the two or more received microphone signals to enable derivation of a second captured audio signal having one or more channels based on the intermediate audio data in accordance with at least part of the stored capture control data.

According to another example embodiment, an apparatus for processing two or more microphone signals is provided, the apparatus comprising: a means for obtaining a first captured audio signal having one or more channels derived on basis of said two or more microphone signals in dependence of capture control data that identifies at least one characteristic for derivation of the first captured audio signal; a means for obtaining at least part of said capture control data and intermediate audio data derived on basis of said two or more microphone signals; a means for deriving modified capture control data as a combination of said obtained capture control data and user-definable post-capture control data that identifies at least one characteristic for derivation of a second captured audio signal; and a means for deriving the second captured audio signal having one or more channels based on said intermediate audio data in accordance with the modified capture control data.

According to another example embodiment, an apparatus for processing two or more microphone signals is provided, wherein the apparatus comprises at least one processor; and at least one memory including computer program code, which, when executed by the at least one processor, causes the apparatus to perform at least a method according to one of the example embodiments described in the foregoing.

According to another example embodiment, a computer program is provided, the computer program comprising computer readable program code configured to cause performing at least a method according to one of the example embodiments described in the foregoing when said program code is executed one or more computing apparatuses.

The computer program according to an example embodiment may be embodied on a volatile or a non-volatile computer-readable record medium, for example as a computer program product comprising at least one computer readable non-transitory medium having program code stored thereon, the program which when executed by one or more apparatuses causes the one or more apparatuses at least to perform the operations described hereinbefore for the computer program according to an example embodiment of the invention.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of an audio capturing arrangement according to an example;

FIG. 2 illustrates a block diagram of some components and/or entities of an audio processing arrangement according to an example;

FIG. 3A illustrates a block diagram of a device for implementing some components and/or entities of an audio processing arrangement according to an example;

FIG. 3B illustrates respective block diagrams of devices for implementing some components and/or entities of an audio processing arrangement according to an example;

FIG. 3C illustrates respective block diagrams of devices for implementing some components and/or entities of an audio processing arrangement according to an example;

FIG. 4 illustrates a block diagram of some components and/or entities of an audio processor according to an example;

FIG. 5 schematically illustrates arrangement of a plurality of microphones in a mobile device according to an example;

FIG. 6 illustrates an user interface according to an example;

FIG. 7 illustrates a flowchart depicting a method for spatial audio processing according to an example; and

FIG. 8 illustrates a block diagram of some elements of an apparatus according to an example.

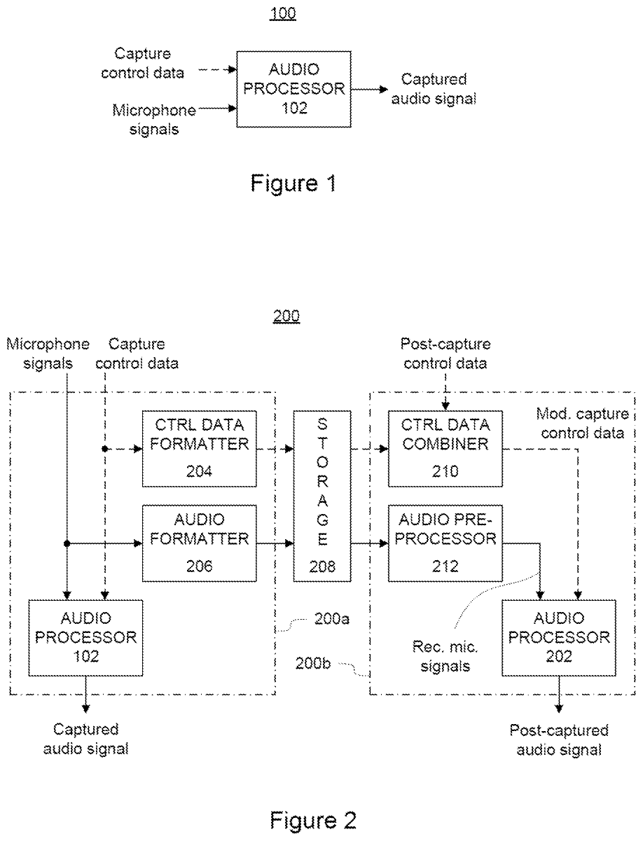

### DESCRIPTION OF SOME EMBODIMENTS

FIG. 2 illustrates a block diagram of some components and/or entities of an audio processing arrangement 200 according to an example. The audio processing arrangement 200 comprises, at least conceptually, a capture arrangement 200a and a post-capture arrangement 200b that in the example of FIG. 2 are linked via a storage 208. The storage 208 may comprise, for example, a memory provided in a device that implements the capture arrangement 200a, that implements the post-capture arrangement 200b, or that implements the audio processing arrangement 200 in its entirety. In other examples, the audio processing arrangement 200 may include further entities and/or some entities depicted in FIG. 2 may be omitted or combined with other entities.

FIG. 2 serves to illustrate logical components of the audio processing arrangement 200 and hence does not impose structural limitations concerning implementation of the audio processing arrangement 200 but, for example, respective hardware means, respective software means or a respective combination of hardware means and software means may be applied to implement any of the logical components of the audio processing arrangement 200 separately from the other logical components of the audio processing arrangement 200, to implement any sub-combination of two or more logical components of the audio processing arrangement 200, or to implement all logical components of the audio processing arrangement 200 in combination.

Referring to FIG. 2, the capture arrangement 200a comprises the audio processor 102, which is arranged to receive capture control data and two or more microphone signals and to derive the captured audio signal based on the one or more microphone signals in accordance with the capture control data, as described in the foregoing with references to the audio processing arrangement 100. Along the lines described therein, the capture control data identifies at least one characteristic for the captured audio signal. The two or more microphone signals may comprise respective digital audio signals that are recorded based on the sound captured by respective microphones arranged in a mobile device such as a mobile phone, a tablet computer, a laptop computer, etc. Without losing generality, the two or more microphones may be referred to as a microphone array. Each of the two or more microphone signals comprises a respective monophonic signal originating from the respective one of the two or more microphones, whereas the two or more microphone signals may be, at least conceptually, considered to constitute a multi-channel audio signal, where each microphone signal represents a respective channel of the multi-channel audio signal. The captured audio signal resulting from operation of the audio processor 102 may comprise a single-channel audio signal or a multi-channel audio signal (that includes two or more audio channels), depending on the definitions received in the capture control data.

Although not shown in FIG. 2, also the captured audio signal may be stored in the storage 208 for subsequent access by a user of the mobile device implementing the capture arrangement 200a and/or for transfer to another device for subsequent access therein. In an example, the captured audio signal may be associated with a video signal that may be also captured concurrently with the two or more microphone signals that serve as basis for deriving the captured audio signal in the audio processor 102. In such a scenario, the captured audio signal may be stored (e.g. in the storage 208) together with the associated video signal in a media container (e.g. a file) according to an applicable media container format such as MPEG4 file. In another example, the captured audio signal is a stand-alone entity that is not associated with a video signal or that is otherwise stored in a dedicated media container (e.g. a file) separately from a video signal that may be associated therewith.

Typically, although not necessarily, the two or more microphone signals include audio information that readily provides or can be processed into a representation of an audio scene in the environment of the mobile device that implements the capture arrangement 200a. In the following, where applicable, the representation of the audio scene provided by the two or more microphone signals is referred to as an original representation of the audio scene. The (perceptual) quality and/or accuracy of the representation of the audio scene captured in the audio information provided by the two or microphone signals depends, for example, on the position and orientation of the microphones of the mobile device with respect to sound sources of the audio scene and on respective positions of the two or more microphones with respect to each other. Along similar lines, the captured audio signal may constitute a multi-channel audio signal (of at least two channels) that conveys a representation of the audio scene in the environment of the mobile device that implements the capture arrangement 200a, which may be similar to the original representation of the audio scene or a modified version thereof.

The term audio scene, as used in the present disclosure, refers to the sound field in the environment of the mobile device that implements the capture arrangement 200a, whereas e.g. the two or more microphone signals provide a representation of the audio scene. An audio scene may involve one or more sound sources at specific spatial positions of the audio scene and/or the ambience of the audio scene. A representation of an audio scene may be defined using a (spatial) audio format, such as binaural audio, audio channels according to a predefined channel configuration, parametric audio, Ambisonics, etc. that enables delivering (audio) information related to one or more directional sound components and/or related to ambient sounds such as environmental sounds and reverberation within the audio scene. Listening to such a representation of an audio scene enables the listener to experience the audio environment similar to as if he or she was at the location the audio scene serves to represent.

The capture arrangement 200a is typically applied to process the two or more microphone signals as a sequence of input frames to derive corresponding sequence of output frames that constitute the captured audio signal. Each input frame includes a respective segment of digital audio signal for each of the microphone signals at a respective predefined sampling frequency and each output frame includes a respective segment of digital audio signal for each channel of the captured audio signal at a respective predefined sampling frequency. In typical example, the capture arrangement 200a employs a fixed predefined frame length such that each frame comprises respective L samples for each channel of the respective audio signal (i.e. the microphone signal(s) and the captured audio signal), which at the respective predefined sampling frequency maps to a corresponding duration in time. As an example in this regard, the fixed frame length may be 20 milliseconds (ms), which at a sampling frequency of 8, 16, 32 or 48 kHz results in a frame of L=160, L=320, L=640 and L=960 samples per channel, respectively. The frames may be non-overlapping or they may be partially overlapping. These values, however, serve as non-limiting examples and frame lengths and/or sampling frequencies different from these examples may be employed instead, depending e.g. on the desired audio bandwidth, on desired framing delay and/or on available processing capacity.

Still referring to FIG. 2, the capture arrangement 200a further comprises a control data formatter 204 for extracting at least some of the definitions conveyed in the capture control data and an audio formatter 206 for extracting at least part of audio information conveyed in the two or more microphone signals. The definitions extracted from the capture control data by the control data formatter 204 and the audio information extracted from the two or more microphone signals by the audio formatter 206 are stored on the storage 208 for subsequent use by the post-capture arrangement 200b.

Still referring to FIG. 2, the control data formatter 204 is arranged to extract at least part of the capture control data and make it available for the post-capture arrangement 200b as stored capture control data. In this regard, the control data formatter 204 may extract at least some definitions received in the capture control data and store them in the storage 208 in a predefined capture control data format for subsequent access by the post-capture arrangement 200b. The capture control data received at the control data formatter 204 preferably includes full description of the general audio characteristics of the audio processing applied by the audio processor 102 and full information on application of the of the audio processing functions available in the audio processor 102 are (to be) applied and, if applicable, respective audio processing parameters for controlling application of the respective audio processing function. Consequently, the capture control data received by the control data formatter includes a full description of audio characteristics and audio processing parameters that enable processing the two or more microphone signals received at the capture arrangement 200a into the captured audio signal.

The capture control data format applied by the control data formatter 204 for the stored capture control data may include a sequence of control data entries, each control data entry identifying either a respective general audio characteristic of the audio capture or identifying an applied audio processing function of the audio processor 102, possibly together with respective audio processing parameters. According to an example, a control data entry comprises an indication of timing (e.g. a starting time and/or an ending time) assigned for the respective control data entry, the general audio characteristic or an audio processing function associated with respective control data entry, and possible audio processing parameters (to be) applied for controlling application of the respective audio processing function. In another examples, the timing associated with a control data entry may be implicit e.g. based on the position of the control data entry in the sequence of control data entries (e.g. if a dedicated control data entry is provided for each frame of the underlying audio signal) or based on another structural aspect the capture control data format. In such examples the timing indications may be omitted from the control data entries.

In a non-limiting example, a control data entry of the stored capture control data stored by the control data formatter 204 may include a timestamp that indicates the starting time with respect to a reference time (e.g. as seconds with respect to the beginning of the underlying audio signal), an identification of the general audio characteristic or an identification of an audio processing function associated with the respective control data entry, and, if applicable, one or more audio parameters applied for controlling application of the respective audio processing function, e.g. as shown in the following example.

| | Audio characteristic/ | Audio |
|---|---|---|
| Time | processing function | parameter(s) |
| 0.0 | inputChannels | 4 |
| 0.0 | outputChannels | 2 |
| 0.0 | devicelD | dev1 |
| 0.0 | bitrate | 512 |
| 0.0 | agcMode | auto |
| 5.0 | focusMode | on |
| 5.0 | focusGain | 4.0 |
| 5.0 | focusAzimuth | 0.0 |
| 5.5 | focusAzimuth | 90.0 |
| 6.0 | focusAzimuth | 180.0 |

The control data entries may be provided in human-readable (text) format or in a computer-readable (binary and/or encoded) format. The control data formatter 204 provides the stored capture control data as metadata associated with the audio data extracted from the two or more microphone signals by the audio formatter 206. In an example, the control data formatter 204 writes the stored capture control data in the storage 208 in a separate (or dedicated) file. In another example, the control data formatter 204 embeds the stored capture control data into another file stored in the storage 208, e.g. as metadata included in the file that (also) stores the audio data extracted from the two or more microphone signals by the audio formatter 206.

The control data formatter 204 may include all received capture control data in the stored capture control data, thereby enabling subsequent reconstruction of the captured audio signal by the post-capture arrangement 200b. In another example, the control data formatter 204 includes only a subset of the received capture control data in the stored capture control data in order to reduce the amount of storage (and/or data transfer) capacity required for the metadata. As an example in this regard, the control data formatter 204 may be arranged to include in the stored capture control data respective definitions that pertain to certain (first) one or more predefined general audio characteristics or audio processing functions and/or to omit from the stored captured control data respective definitions that pertain to certain (second) one or more predefined general audio characteristics or audio processing functions. As another example, the amount of stored capture control data may be reduced by reducing the update rate of a given audio parameter associated with an applied audio processing function, e.g. such that the updated value for the given audio parameter is included at N frame intervals instead of including the respective parameter value in each frame. Consequently, the post-capture arrangement 200b may interpolate the audio parameter value for those frames for which the audio parameter value is not explicitly indicated.

Still referring to FIG. 2, the audio formatter 206 is arranged to derive intermediate audio data based on the two or more microphone signals. In this regard, the audio formatter 206 may be arranged to extract at least part of audio information conveyed in the two or more microphone signals and store the extracted audio information in the storage 208 as the intermediate audio data for subsequent access by the post-capture arrangement 200b. In an example, the audio formatter 206 stores the received two or more microphone signals as such, thereby enabling the post-capture arrangement 206 to carry out the audio processing therein based on the same audio content that was available for the capture arrangement 200a. In such an example, the audio information stored by the audio formatter 206 in the storage 208 may be referred to as ‘raw audio signal’ or as ‘raw audio data’ that includes two or more intermediate audio signals. Herein, each intermediate audio signal may be provided as a respective single-channel (monophonic) audio signal or as a respective multi-channel audio signal (having two or more channels).

In other examples, the audio formatter 206 may apply one or more audio processing functions to process the received two or more microphone signals into the intermediate audio data for storage in the storage 208. Examples of audio processing functions that may be applied by the audio formatter 206 include one or more of the following: gain control, audio equalization, noise suppression (such as wind noise removal) or audio enhancement processing of other kind, change (e.g. reduction) of sampling rate, change (e.g. reduction) of audio sample resolution, change (e.g. reduction) of the number of channels, audio encoding, conversion to a selected or predefined audio format (e.g. binaural, audio channels according to a predefined channel configuration, parametric audio, Ambisonics), etc. In such an example, the intermediate audio data may include one or more intermediate audio signals, possibly complemented by audio metadata. Typically, however, no or only a few audio processing functions are applied in the audio formatter 206 to retain as much as possible of the audio information conveyed by the two or more microphone signals (e.g. in view of the available capacity of the storage 208 and/or in view of the available processing capacity) in order to provide the post-capture arrangement 200b with the intermediate audio data that is (significantly) closer in information content to the two or more microphone signals received at the capture arrangement 200a than the captured audio signal output from the audio processor 102. Typically, although not necessarily, the stored capture control data (stored e.g. as metadata) in the storage 208 by the control data formatter 206 includes respective control data entries pertaining only to those audio processing functions that are applied by the audio processor 102, whereas the one or more predefined audio processing functions possibly applied by operation of the audio formatter 206 are not identified in the stored capture control data provided in the storage 208. However, information that identifies at least some of the audio processing functions applied by the audio formatter 206 in derivation of the intermediate audio data may be stored in the storage 208 together with the one or more intermediate audio signals as metadata associated thereto, either in a separate (or dedicated) file or embedded into the file that (also) stores the one or more intermediate audio signals.

The audio formatter 206 may store the intermediate audio data using a suitable storage format known in the art. As an example, if the intermediate audio data is provided as one or more time-domain multi-channel audio signals, they may be stored in the storage 208 in the PCM format (e.g. as a .wav file). In another example, if the audio formatter 206 applies a selected or predefined audio encoding to the two or more microphone signals (or to one or more signals derived on basis of the two or more microphone signals) to derive the intermediate audio data, this information may be stored using a predefined container (or encapsulation) format defined for the respective audio encoder.

Still referring to FIG. 2, the post-capture arrangement 200b comprises a control data combiner 210 for deriving modified capture control data based on the stored capture control data and post-capture control data, and an audio preprocessor 212 for deriving one or more reconstructed signals based on the intermediate audio data. The post-capture arrangement 200b further comprises an audio processor 202 for deriving a post-captured audio signal based on the one or more reconstructed signals in accordance with the modified capture control data. The post-captured audio signal derived by the audio processor 202 (also) reflects control information defined via the post-capture control data, thereby providing an audio signal that may be applied instead of the captured audio signal obtained from the audio processor 102, e.g. by replacing the captured audio signal with the post-captured audio signal as part of an audio-visual content and/or playing back the post-captured audio signal instead of the captured audio signal. Herein, the terms captured audio signal and post-captured audio signal are applied to refer to the outputs of the audio processor 102 and the audio processor 202, respectively. However, especially the latter one is a choice made for editorial clarity of the description and these signals may be, alternatively, referred to as a first captured audio signal and a second captured audio signal, respectively.

As described in the foregoing, the intermediate audio data comprises audio information that includes one or more intermediate audio signals (possibly complemented by audio metadata). The intermediate audio data conveys the original representation of the audio scene (i.e. the one provided by the two or more microphone signals received at the capture arrangement 200a) or an approximation thereof. As also described in the foregoing, each of the intermediate audio signals included in the intermediate audio data may be provided as a respective single-channel (monophonic) audio signal or as a respective multi-channel audio signal (having two or more channels). The post-captured audio signal resulting from operation of the post-capture arrangement 200b typically comprises a multi-channel audio signal (of at least two channels) that conveys a representation of the audio scene, whereas in some examples the post-captured audio signal may comprise as single-channel (monophonic) audio signal, depending on the definitions provided in the modified capture control data.

The post-capture arrangement 200b is typically applied to process the intermediate audio data (e.g. the one or more intermediate audio signals) as a sequence of input frames to derive a corresponding sequence of output frames that constitute the post-captured audio signal. The description of the frame structure provided in the foregoing with references to the capture arrangement 200a applies also to the post-capture arrangement 200b, mutatis mutandis.

As described in the foregoing, the audio preprocessor 212 is arranged to derive the one or more reconstructed signals based on the intermediate audio data. In this regard, the audio preprocessor 212 obtains (e.g. reads) the intermediate audio data from the storage 208 and, depending on the content and format applied for the intermediate audio data, either applies the two or more intermediate audio signals included therein as such as respective two or more reconstructed signals, or subjects the one or more intermediate audio signals included in the intermediate audio data to one or more audio processing functions to derive the one or more reconstructed signals for further processing by the audio processor 202.

In case the intermediate audio data obtained from (the capture arrangement 200a via) the storage 208 includes two or more intermediate audio signals provided as respective copies of the two or more microphone signals originally received at the capture arrangement 200a (i.e. as ‘raw audio signal’), no audio processing by the audio preprocessor 212 is necessary but the two or more intermediate audio signals may be passed as such as the respective two or more reconstructed signals for processing by the audio processor 202. For example in case the intermediate audio data obtained from the storage 208 includes one or more intermediate audio signals that provide encoded representation provide an encoded representation of the two or more microphone signals originally received at the capture arrangement 200a, the audio preprocessor 212 may be arranged to apply respective audio decoding to the one or more intermediate audio signals to derive the one or more reconstructed signals.

As described in the foregoing, the audio processor 202 is arranged to derive the post-captured audio signal based on the one or more reconstructed signals in accordance with the modified capture control data. The audio processor 202 may be similar to the audio processor 102 with respect to its operation and capabilities. Hence, the audio processor 202 may enable a plurality of audio processing functions, whereas application of the audio processing functions available therein may be controlled via the modified capture control data. Non-limiting examples of audio processing functions that may be available in the audio processor 202 are described in the foregoing with references to the audio processor 102.

Although not shown in FIG. 2, also the post-captured audio signal may be stored in the storage 208 for subsequent access by a user of the device implementing the post-capture arrangement 200b and/or for transfer to another device for subsequent access therein. As examples in this regard, the post-captured audio signal may be provided for playback as an alternative to the captured audio signal that may be also available in the storage 208 or the post-captured audio signal may replace the captured audio signal in the storage 208. In case the captured audio signal is provided in the storage 208 in the same media container (e.g. in a MPEG 4 file), the post-captured audio signal may replace the captured audio signal in the media container.

As described in the foregoing, the control data combiner 210 is arranged to derive modified capture control data based on the stored capture control data and post-capture control data. In this regard, the control data combiner 210 obtains (e.g. reads) the stored capture control data from the storage 208. While the stored capture control data identifies at least one audio characteristics that has been applied in derivation of the captured audio signal in the capture arrangement 200a (and that may be applied for derivation of the post-captured audio signal), each of the post-capture control data and the resulting modified capture control data identifies at least one audio characteristics that is (to be) applied for derivation of the post-captured audio signal in the post-capture arrangement 200b.

Referring back to the characteristics of the capture control data described in the foregoing in context of the capture arrangement 200a, the stored control data identifies at least one audio characteristic applied for derivation of the captured audio signal, which may also be applied for derivation of the post-captured audio signal. In this regard, the stored capture control data may identify general audio characteristics pertaining to the received microphone signals (i.e. an input audio of the capture arrangement 200a) and/or to the captured audio signal (i.e. an output audio of the post-capture arrangement 200a) and/or the stored capture control data may define which of the audio processing functions available in the audio processor 102 have been applied in deriving the captured audio signal in the audio processor 102 and, if applicable, respective audio processing parameters that were used for controlling application of the respective audio processing functions. Examples of both general audio characteristics and audio processing functions available in the audio processor 102 are described in the foregoing.

Along the lines described in the foregoing in context of the capture arrangement 200a, the stored capture control data is stored in the storage 208 using a predefined capture control data format that may comprise a sequence of control data entries, each control data entry identifying either a respective general characteristic of the captured audio signal or identifying an audio processing function applied for processing the one or more microphone signals in the capture arrangement 200a, possibly together with respective audio processing parameters. Depending on the information available as the stored capture control data, the control data combiner 210 may interpolate between data points available in the stored capture control data to ensure availability of capture control data for the full duration (e.g. for each frame) of the corresponding intermediate audio data also stored in the storage 208.

Still referring to FIG. 2, the control data combiner 210 further receives the post-capture control data that identifies at least one audio characteristic for derivation of the post-captured audio signal. In this regard, the post-capture control data may identify various general audio characteristics of the post-captured audio signal (i.e. an output audio of the post-capture arrangement 200b), such as the number of output channels, the sampling rate of the output audio, the sample resolution of the output audio (e.g. the number of bits per audio sample), the applied output audio format (e.g. binaural, loudspeaker channels according to a specified channel configuration, parametric audio, Ambisonics), etc. In addition to the general audio characteristics of the post-captured audio signal, the post-capture control data may define which of the audio processing functions available in the audio processor 202 are (to be) applied and, if applicable, respective audio processing parameters for controlling application of the respective audio processing functions. An example of an audio processing function applicable by the audio processor 202 involves audio focusing in accordance with user-definable focus direction and focus amount. This and other examples of audio processing functions that may be available in the audio processor 202 are described in more detail in the foregoing and in the following.

The post-capture control data may comprise definitions originating from user input received upon initiating or carrying out a post-capturing session. In this regard, the post-capture control data, and hence the corresponding characteristics of operation of the audio processor 202, may remain unchanged throughout the post-capturing session. On the other hand, at least some aspects of the post-capture control data, and hence the corresponding characteristics of operation of the audio processor 202, may vary or be varied during the post-capturing session. Such variations may include enabling or disabling a certain audio processing function during the post-capturing session or changing characteristics of a certain audio processing function during the post-capturing session, for example, in response to user input received during the post-capturing session.

Still referring to FIG. 2, the control data combiner 210 is arranged the derive the modified capture control data by combining the information received in the stored capture control data with the information received in the post-capture data. An underlying principle of combining these pieces of information is that in case of overlap or conflict between a first definition included in the stored capture control data and a second definition included in the post-capture control data, the latter one prevails.

Hence, the control data combiner 210 may be arranged to one or more of the following:
omit one or more audio characteristics identified in the stored capture control data,
replace one or more audio characteristics identified in the stored capture control data with one or more audio characteristics identified in the post-capture control data,
modify one or more audio characteristics identified in the stored capture control data based on one or more audio characteristic identified in the post-capture control data,
complement the stored capture control data with one or more audio characteristics identified in the post-capture control data.

Consequently, the post-capture arrangement 200b enables a user to omit, to replace, to modify and/or to complement the selections made with respect to audio characteristics applied for derivation of the captured audio signal to derive the post-captured audio signal that provides improved perceptual audio quality and/or that otherwise more closely reflects the preferences of the user of the post-capture arrangement 200b.

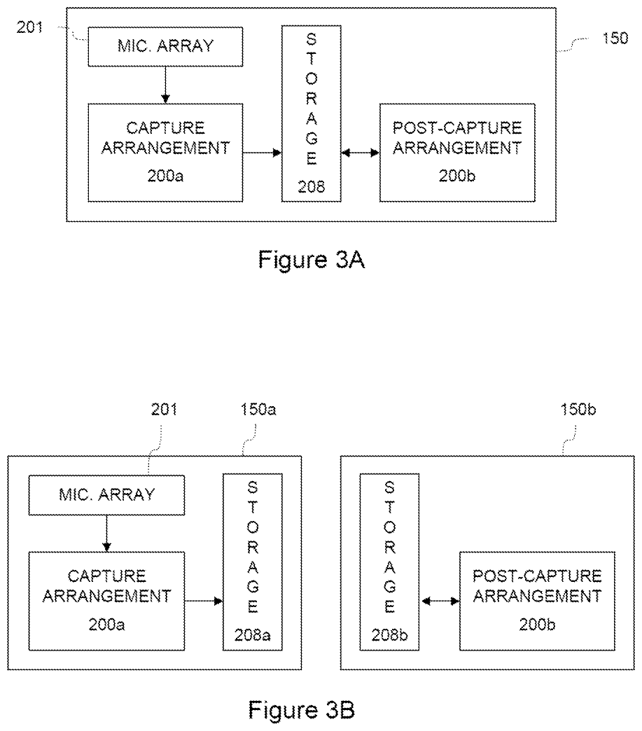

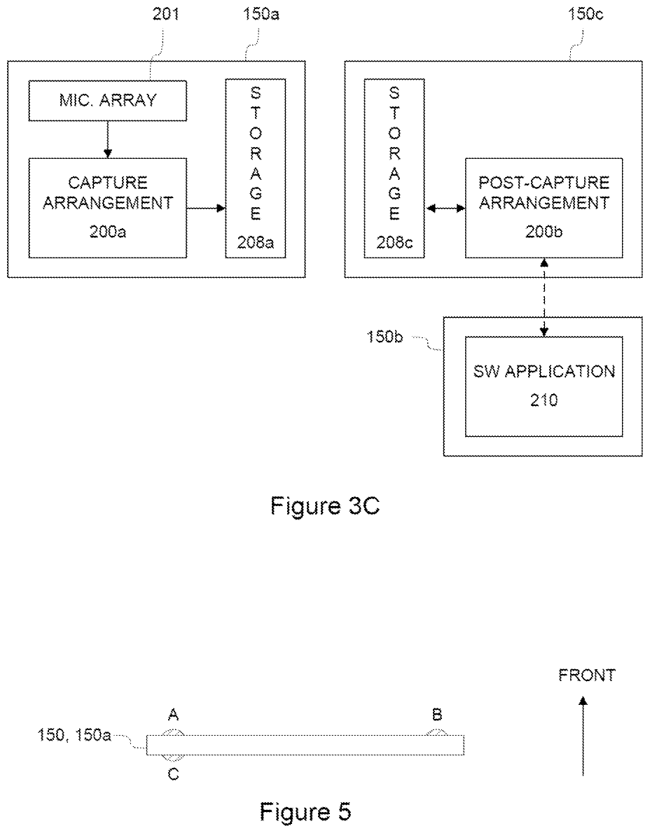

According to an example, as schematically illustrated in FIG. 3A, the capture arrangement 200a and the post-capture arrangement 200b may be implemented in a mobile device 150, which may be provided as a portable electronic device such as a mobile phone, a portable media player, a tablet computer, a laptop computer, etc. The mobile device 150 may further include two or microphones (e.g. a microphone array) 201 arranged to provide the respective two or more microphone signals that constitute the basis of the audio processing by the audio processing arrangement 200. Therein, the storage 208 may be provided as a memory of the mobile device 150 and it may be directly accessible by both the capture arrangement 200a and the post-capture arrangement 200b.

In another example, as schematically illustrated in FIG. 3B, elements of the audio processing arrangement 200 may be distributed into two devices such that a mobile device 150a comprises the capture arrangement 200a together with the two or more microphones 201 and a storage 208a, whereas a device 150b comprises the post-capture arrangement 200b together with a storage 208b. Therein, the mobile device 150a may be provided, for example, as a portable electronic device such as a mobile phone, a portable media player, a tablet computer, a laptop computer, etc. whereas the device 150b may be provided as a portable mobile device or as an electronic device of other type, such as a desktop computer etc. In the example arrangement of FIG. 3B, the capture arrangement 200a operates to write the stored capture control data and the intermediate audio data (and possibly also the captured audio signal and/or video content associated with the captured audio signal) in the storage 208a in the mobile device 150a. According to an example, the data stored in the storage 208a by the capture arrangement 200a may be transferred e.g. via a communication link, via a communication network or via usage of removable memory device to the storage 208b in the device 150b, and the post-capture arrangement 200b may read at least the stored capture control data and the intermediate audio data from (and possibly write the post-captured audio signal to) the storage 208b. In another example, the data stored in the storage 208a by the capture arrangement 200a may be first transferred (e.g. uploaded) in a storage provided in a server device that is communicatively coupled (e.g. via a communication network) to the mobile device 150a, whereas the device 150b may be likewise communicatively coupled (e.g. via a communication network) to the server and the post-capture arrangement 200b operated in the device 150b may read at least the stored capture control data and the intermediate audio data from (and possibly write the post-captured audio signal to) the storage in the server.

In a further example, as schematically illustrated in FIG. 3C, elements of the audio processing arrangement 200 may be distributed into several devices differently from that described in the foregoing in context of the example of FIG. 3B. As in the example of FIG. 3B, also the example of FIG. 3C includes the mobile device 150a and the device 150b, together with a server device 150c. As in the example of FIG. 3B, the mobile device 150a comprises the capture arrangement 200a together with the two or more microphones 201 and a storage 208a, the server device 150c comprises the post-capture arrangement 200b and a storage 208c. The mobile device 150a is communicatively coupled (e.g. via a communication network) to the server device 150c and provides the stored capture control data and the intermediate audio data (and possibly also the captured audio signal and/or video content associated with the captured audio signal) to the storage 208c in the server device 150c. The device 150b is (also) communicatively coupled to the server device 150c and it is provided with a software application 210 that enables the user to (remotely) operate the post-capture arrangement 200b provided in the server device 150c. In this regard, at least part of the post-capture control data may be defined via operation of the application 210 in the device 150b and delivered to the server device 150c, whereas the processing involved in operation of the post-capture arrangement 200b is carried out in the server device 150c, which may involve the server device 150c accessing the stored capture control data and the intermediate audio data (and possibly also the captured audio signal and/or video content associated with the captured audio signal) provided in the storage 208c and possibly also (at least partially) replacing the captured audio signal in the storage 208c with the post-captured audio signal resulting from operation of the post-capture arrangement in the server device 150c. Consequently, the user may apply the device 150b to access (e.g. download) the post-captured audio signal available in the memory 208c of the server device 150c (possibly together with the associated video content).

As described in the foregoing, a plurality of audio processing functions may be available in the audio processors 102, 202 for modification of the two or more microphone signals, the one or more reconstructed signals or one or more signals derived therefrom. Many of these audio processing functions may result changes in the audio information conveyed in the respective processed audio signal(s) that cannot be reversed or ‘undone’, at least not to the full extent. A few examples in this regard are provided in the following:
Signal level adjustment (e.g. gain control) or audio equalization may lead to (inadvertent) saturation of the processed audio signal(s), thereby losing at least part of the audio information conveyed in the unprocessed audio signal(s).
Dynamic range compression results in loss of the fine structure of the (time-domain) audio envelope of the unprocessed audio signal(s) that may not be fully recoverable.
Audio enhancement processing such as noise removal discards part of the audio information that is present in the unprocessed audio signal(s).
Audio focusing or modification or listening orientation modifies the representation of the audio scene conveyed by the unprocessed audio signals in a manner that cannot by fully undone or redone based on the resulting processed audio signal(s).
Audio encoding typically involves lossy compression that aims at discarding perceptually less important characteristics of the audio information conveyed by the unprocessed audio signal(s) in view of the required compression ratio (e.g. in view of available bit-rate) and/or available processing capacity, thereby resulting loss of information that cannot be recovered based on the resulting processed audio signal(s).
Processing an audio signal into a (spatial) audio format such as binaural audio, loudspeaker channels according to a specified channel configuration, parametric audio or Ambisonics is generally not revertible.

Considering the examples above, a user of the post-capture arrangement 200b may, for example, prefer adjusting the gain or audio equalization settings differently from those applied in the capture arrangement 200a, prefer omitting one or more audio enhancement functions that were applied in the capture arrangement 200a, prefer omitting audio focusing applied in the capture arrangement 200a or apply audio focusing with different settings, prefer omitting audio encoding applied in the capture arrangement 200a, prefer applying audio encoding technique different from that applied in the capture arrangement 200a, prefer converting the microphone signals into a (spatial) audio format different from that applied in the capture arrangement 200a, etc.

In the course of the operation of the capture arrangement 200a the audio processor 102 typically derives the captured audio signal based on the two or more microphone signals in accordance with the capture control data frame by frame as further audio comes available from the two or more microphones. Consequently, when processing a given frame of the two or more microphone signals, the audio processing functions available in the audio processor 102 typically do not have any (or have limited) access to audio content of the two or more microphone signals that follows the given frame. On the other hand, the audio processor 202 in the post-capture arrangement 200b typically has full access to the one or more reconstructed signals in their entirety when applying the audio processing functions available therein, including also frames of the one or more reconstructed signals that follow the frame currently under processing. Consequently, the audio processor 202 may be arranged to apply one or more of the audio processing functions available therein in manner that differs from application of the respective audio processing function in the audio processor 102, e.g. such that the signal content in some of the future frames is taken into account when processing a given frame. A non-limiting example in this regard involves signal level adjustment by an automatic gain control (AGC) function that may benefit from access to the one or more reconstructed signals in their entirety when deriving and applying a gain for a given frame of the one or more reconstructed signals.

In the following, a particular example that pertains to controlling operation of audio focusing (or “audio zooming”) is described in more detail. Audio focusing enables modifying the representation of an audio scene conveyed by a multi-channel audio signal by adjusting (e.g. one of increasing or decreasing) the sound level in a user-selectable spatial portion of the audio scene by a user-definable amount in relation to other spatial portions of the audio scene. Hence, the audio focusing enables modifying the multi-channel audio signal (and hence the representation of the audio scene conveyed by the multi-channel audio signal) e.g. such that the sounds in a user selectable focus direction are emphasized with respect to sounds in other directions by a user-selectable focus amount. Herein, the audio focusing may be applied to the two or more microphone signals (by the audio processor 102) and/or to the one or more reconstructed signals (by the audio processor 202). In an example, the operation of audio focusing may be controlled via user-definable focus direction and focus amount parameters, which may be provided as input to the audio processing arrangement as part of the capture control data and/or as part of the post-capture control data: the focus direction defines the spatial portion (e.g. one or more spatial directions or a range of spatial directions) of the audio scene to be modified and the focus amount defines the extent of adjustment to be applied to the sound level in the selected spatial portion of the audio scene. In particular, the user may define a first focus direction and a first focus amount upon operating the capture arrangement 200a, whereas the user or another user may define a second focus direction (that is different from the first focus direction) and/or a second focus amount (that is different from the first focus amount) upon operating the post-capture arrangement 200b. Consequently, the audio processing arrangement 200 enables correcting or otherwise re-defining the audio focusing defined by the first focus direction and the first focus amount applied upon deriving the captured audio signal (via operation of the capture arrangement 200a) by defining the second focus direction and the second focus amount differently for derivation of the post-captured audio signal (via operation of the post-capture arrangement 200b) e.g. to obtain audio focusing that better reflects his/her preferences.

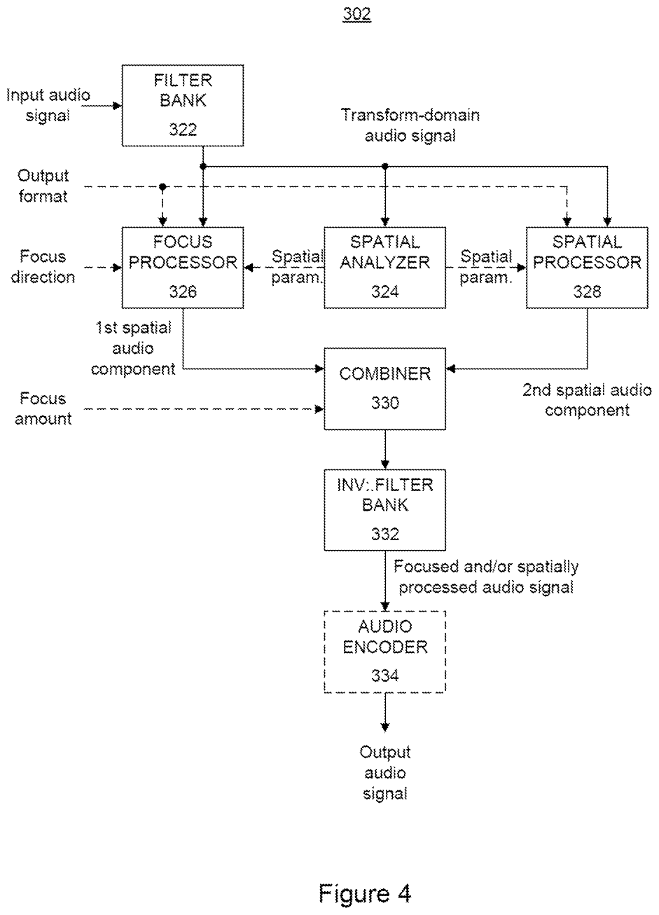

FIG. 4 illustrates a block diagram of some components and/or entities of an audio processor 302 according to an example, which audio processor 302 may be applied as the audio processor 102 and/or as the audio processor 202. The audio processor 302 is at least arranged to carry out audio focusing in accordance with indicated focus direction and focus amount. The audio processor 302 comprises a filter bank 322 for transforming the input spatial audio signal from time domain into a transform domain, a spatial analyzer 324 for estimating spatial characteristics of the input audio signal, a focus processor 326 for generating a first spatial audio component that represents a focus portion in the representation of the audio scene conveyed by the input audio signal, a spatial processor 328 for generating a second spatial audio component that represents a non-focus portion in the representation of the audio scene conveyed by the input audio signal, a combiner 330 for combining the first and second audio components into a focused audio signal, an inverse filter bank 332 for transforming the focused audio signal from the transform domain back to the time domain, and, optionally, an audio encoder 334 for encoding the focused audio signal for storage (e.g. in the storage 208) and/or for transfer to another device. In other examples, the audio processor 302 may include further entities and/or some entities depicted in FIG. 4 may be omitted or combined with other entities.

FIG. 4 serves to illustrate logical components of the audio processor 302 and hence does not impose structural limitations concerning implementation of the audio processor 302 but, for example, respective hardware means, respective software means or a respective combination of hardware means and software means may be applied to implement any of the logical components of the audio processor 302 separately from the other logical components of the audio processor 302, to implement any sub-combination of two or more logical components of the audio processor 302, or to implement all logical components of the audio processor 302 in combination.

As illustrated in FIG. 4, the audio processor 302 derives a multi-channel output audio signal based on a multi-channel input audio signal in dependence of focus direction focus amount and output format provided as respective control inputs to the audio processor 302. Hence, in context of the audio processor 302 the multi-channel input audio signal conveys a first representation of an input audio scene (e.g. the original representation provided by the two or more microphone signals or the one captured in the intermediate audio data) and the multi-channel output audio signal conveys a second representation of the input audio scene, which may be the same as, substantially similar to, or different from the first representation.

When applied as the audio processor 102, channels of the input audio signal to the audio processor 302 comprise respective two or more microphone signals received at the capture arrangement 200a and channels of the one or more output audio signals of the audio processor 302 represent respective channels of the captured audio signal, whereas when applied as the audio processor 202, the channels of input audio signal to the audio processor 302 comprise respective one or more reconstructed signals obtained at the post-capture arrangement 200b and the channels of the output audio signal of the audio processor 302 represent respective channels of the post-captured audio signal.

In context of the audio processor 302, the focus direction refers to a user-selectable spatial direction of interest. The focus direction may be, for example, a certain direction of the audio scene in general. In another example, the focus direction or a direction in which a sound source of interest is currently positioned. In the former scenario, the user-selectable focus direction typically denotes a spatial direction that stays constant or changes infrequently since the focus is predominantly in a specific spatial direction, whereas in the latter scenario the user-selected focus direction may change more frequently since the focus is set to a certain sound source that may (or may not) change its position of the audio scene over time. In an example, the focus direction may be defined, for example, as an azimuth angle that defines the spatial direction of interest with respect to a first predefined reference direction and/or as an elevation angle that defines the spatial direction of interest with respect to a second predefined reference direction.

The focus amount refers to a user-selectable change in relative sound level of sound arriving from the focus direction. The focus amount may be selectable between zero (i.e. no focus) and a predefined maximum focus amount. The focus amount may be applied by mapping the user-selected focus amount into a scaling factor in a range from 0 to 1 and modifying the sound level of one or more sound components in a representation of the audio scene arriving from the focus direction (in relation to other sounds in the representation of the audio scene) in accordance with the scaling factor. As described in the foregoing, the filter bank 322 is arranged to transform the channels of input audio signals from time domain into a transform domain. In this regard, the processing by the filter bank 322 may comprise transforming each channel of each frame of the input audio signal from the time domain to the transform domain. Transforming a frame to the transform domain may involve using information also from one or more frames that (immediately) precede the current frame, depending on characteristics of the applied transform technique and/or the filter bank. Without losing generality, the transform domain may be considered as a frequency domain and the transform-domain samples resulting from the transform may be referred to as frequency bins. The filter bank 322 employs a predetermined transform technique known in the art. In an example, the filter bank employs short-time discrete Fourier transform (STFT) to convert each channel of the input audio signal into a respective channel of the transform-domain signal using a predefined analysis window length (e.g. 20 milliseconds). In another example, the filter bank 322 employs complex-modulated quadrature-mirror filter (QMF) bank for time-to-frequency-domain conversion. The STFT and QMF bank serve as non-limiting examples in this regard and in further examples any suitable technique known in the art may be employed for creating the transform-domain signals. The inverse filter bank 332 is arranged to transform each frame of the focused audio signal (obtained from the combiner 330) from the transform domain back to the time domain for provision to the (optional) audio encoder 334. The inverse filter bank 332 employs an inverse transform matching the transform applied by the filter bank 322, e.g. an inverse STFT or inverse QMF. The filter bank 322 and the inverse filter bank 332 are typically arranged to process each channel of the audio signal signal separately from the other channels.

The filter bank 322 may further divide each channel of the input audio signal into a respective plurality of frequency sub-bands, thereby resulting in the transform-domain input audio signal that provides a respective time-frequency representation for each channel of the input audio signal. A given frequency band in a given frame of the transform-domain audio signal may be referred to as a time-frequency tile, and the processing of the audio signal between the filter bank 322 and the inverse filter bank 332 is typically carried out separately for each time-frequency tile in the transform domain. The number of frequency sub-bands and respective bandwidths of the frequency sub-bands may be selected e.g. in accordance with the desired frequency resolution and/or available computing power. In an example, the sub-band structure involves 24 frequency sub-bands according to the Bark scale, an equivalent rectangular band (ERB) scale or 3^{rd} octave band scale known in the art. In other examples, different number of frequency sub-bands that have the same or different bandwidths may be employed. A specific example in this regard is a single frequency sub-band that covers the input spectrum in its entirety or a continuous subset thereof. Another specific example is consideration of each frequency bin as a separate frequency sub-band.

As described in the foregoing, the spatial analyzer 324 is arranged to estimate spatial characteristics of the input audio signal based on the transform-domain signal obtained from the filter bank 322. The processing carried out by the spatial analyzer 324 may be referred to as spatial analysis, which may be based on signal energies and correlations between audio channels in a plurality of time-frequency tiles of the transform-domain audio signal. The outcome of the spatial analysis may be referred to as spatial audio parameters, which are provided for the focus processor 326 and for the spatial processor 328. The spatial audio parameters may include at least the following spatial audio parameters for one or more frequency sub-bands and for a number of frames (i.e. for a number of time-frequency tiles):
A direction indication that indicates a spatial direction of a directional sound component in the respective time-frequency tile. The sound direction may be indicated, for example, as an azimuth angle with respect to a front direction or with respect to another predefined reference direction.
An energy ratio that indicates a ratio between the energy of the directional sound component in the respective time-frequency tile and the total energy of the respective time-frequency tile, i.e. for the frequency sub-band k for time index n. An energy ratio indicates the relative strength of the directional sound component in the respective time-frequency tile and has a value in the range 0 . . . 1.

The spatial analysis may be carried out using any suitable spatial analysis technique known in the art, while details of the spatial analysis are outside the scope of the present disclosure. As a non-limiting example, the input audio signal has three audio channels originating from respective microphones of a three-microphone array schematically illustrated in FIG. 5 and the technique disclosed in WO 2018/091776 may be applied to determine the spatial audio parameters. FIG. 5 schematically depicts a mobile device, e.g. the mobile device 150, 150a, from above, such that the front direction is upwards in the illustration of FIG. 5. The reference designators A, B and C serve to indicate respective positions of the three microphones of the microphone array of the mobile device. In this example, the spatial analysis involves deriving an azimuth angle between −90 and 90 degrees based on a first correlation analysis carried out to find a time delay value that maximizes the correlation between respective audio signals originating from the microphones A and B. A second correlation analysis at different delays is also performed based on respective audio signals originating from the microphones A and C. However, due to a relatively small distance between the microphones A and C the delay analysis is fairly noisy, and therefore only a binary direction indication that indicates either a front direction or a back direction may be derived from that microphone pair. In case the outcome of the second correlation analysis indicates front direction, the azimuth angle obtained from the first correlation analysis is applied as the spatial direction in the respective time-frequency tile. In case the outcome of the second correlation analysis indicates back direction, the azimuth angle obtained from the first correlation analysis is mirrored to the rear side, thereby resulting in an azimuth angle that indicates the spatial direction in a range from −180 to 180 degrees (with respect to the front direction): for example, an azimuth angle of 80 degrees may be mirrored to an azimuth angle of 100 degrees and an azimuth angle of −20 degrees may be mirrored to an azimuth angle of −160 degrees. This example further involves deriving the energy ratio for each time-frequency tile based on the normalized cross-correlation computed based on the respective audio signals originating from the microphones A and B. The directions (e.g. the azimuth angles in a plurality of frequency sub-bands) and the energy ratios (derived e.g. based on the normalized cross-correlations in a plurality of frequency sub-bands) are provided for the focus processor 326 and the spatial processor 328 as the spatial audio parameters pertaining to a respective frame of the input audio signal.

As described in the foregoing, the focus processor 326 is arranged to generate the first spatial audio component that represents a focus portion in a representation of the audio scene conveyed by the input audio signal. The processing carried out by the focus processor 326 may be referred to as focus processing, which may be performed based on the transform-domain audio signal (obtained from the filter bank 322) in dependence of the spatial audio parameters (obtained from the spatial analyzer 324) and further in dependence of the focus direction and an output format indication (both derived based on user input).

The output of the focus processor 326 is the (transform-domain) first audio component, where at least some sound components of a portion in a representation of the audio scene indicated by the focus portion parameter are emphasized with respect to the remaining sound components in the representation of the audio scene and positioned in their original spatial position in the representation of the audio scene. The focus processing may be carried out using any suitable audio focusing technique known in the art, while details of the focus processing are outside the scope of the present disclosure.

According to a non-limiting example, the focus processing comprises a beamforming and a post-filtering in one or more frequency sub-bands and in a number of frames (i.e. in a number of time-frequency tiles) as outlined in the following:
The beamforming derives a weighted-sum of the channels of the transform-domain audio signal in a respective frequency sub-band, where the weights are typically complex-valued and selected or determined such that the sounds arriving from the indicated focus direction are amplified with respect to sounds arriving from other directions in a representation of the audio scene. The beamforming may be static beamforming or adaptive beamforming. An example of the latter is the minimum variance distortionless (MVDR) beamformer known in the art. The output of the beamforming may be referred to as a beamformed audio signal.
The post-filtering involves applying respective gains to the beamformed audio signal in a respective frequency sub-band. The post-filtering gains are selected or determined based on the directions and energy ratios (obtained from the spatial analyzer 324). As an example, the post-filtering gain for a given time-frequency tile may be selected or determined in dependence of the angle between the focus direction and the sound direction indicated for the given time-frequency tile such that the post-filtering gain value decreases with the increasing angle between these two directions (i.e. sounds arriving from directions that are far away from the focus direction are attenuated more than sounds arriving from directions that are close to the focus direction).

The signal that results from the procedure that involves the beamforming and the post-filtering may comprise a single-channel (monophonic) focus signal, which is further processed into the focused (spatial) audio signal in accordance with an audio format indicated by the output format parameter Non-limiting examples in this regard are outlined in the following:
In case the indicated output format is a predefined loudspeaker configuration (e.g. a 5.1-channel surround or 7.1-channel surround), the focus signal may be amplitude panned to the spatial position of the representation of the audio scene indicated by the focus direction for example using vector-base amplitude panning (VBAP) technique known in the art, thereby creating the (spatial) first audio component where the focus signal is arranged in the spatial position of the representation of the audio scene indicated by the focus direction.
In case the indicated output format is (two-channel) binaural audio, the focus signal may be processed into left and right channel signals of the focused audio signal using a pair of head-related transfer functions (HRTFs) selected or determined in accordance with the focus direction in order to create the (spatial) first audio component where the focus signal is arranged in the spatial position of the representation of the audio scene indicated by the focus direction.
In case the indicated output format is Ambisonics, the focus signal may be processed using spherical harmonic gain coefficients selected or determined according to the focus direction, thereby creating the (spatial) first audio component where the focus signal is arranged in the spatial position of the representation of the audio scene indicated by the focus direction.

As described in the foregoing, the spatial processor 328 is arranged to generate the second spatial audio component that represents a non-focus portion of the representation of the audio scene conveyed by the input audio signal. The processing carried out by the spatial processor 328 may be referred to as spatial conversion, which may be performed based on the transform-domain audio signal (obtained from the filter bank 322) in dependence of the spatial audio parameters (obtained from the spatial analyzer 324) and further in dependence of the output format indication (derived based on user input). The output of the spatial processor 328 is the (transform-domain) second audio component processed in accordance with the indicated output format. The spatial conversion may be carried out using any suitable processing technique known in the art, while details of the spatial conversion are outside the scope of the present disclosure.

According to a non-limiting example, the spatial conversion may be provided in one or more frequency sub-bands and in a number of frames (i.e. in a number of time-frequency tiles) as outlined in the following:
1) The transform-domain audio signal of a time-frequency tile is decomposed into respective direct signal part and ambient signal part based on the energy ratios obtained from the spatial processor 324.
2) The direct signal part is processed using one of respective VBAP gains, respective pair of HRTFs or respective Ambisonic gains, depending on the indicated output format, to generate respective direct signal part for each channel of the second spatial audio component.
3) The ambient signal part is processed with respective decorrelators in accordance with the indicated output format to generate respective ambient signal part for each channel of the second spatial audio component. For example, in case the output format is Ambisonics or a predefined loudspeaker configuration, the ambient signal part is processed into channels of the second spatial audio component such that they exhibit incoherence between the channels, whereas in case the output format is binaural audio, the ambient signal part is processed into channels of the second spatial audio component such that they exhibit inter-channel correlation according to the binaural diffuse field correlation
4) The respective direct signal parts and ambient signal parts are combined at each channel of the second spatial audio component

Some approaches known in the art implement the procedure according to steps 1) to 4) above depending on the applied output format, e.g. ones described in Laitinen, Mikko-Ville and Pulkki, Ville, “Binaural reproduction for directional audio coding”, IEEE Workshop on Applications of Signal Processing to Audio and Acoustics, 2009, WASPAA'09, pp. 337-340, IEEE, 2009 and in Vilkamo, Juha, Lokki, Tapio and Pulkki, Ville. “Directional audio coding: Virtual microphone-based synthesis and subjective evaluation”, Journal of the Audio Engineering Society 57, no. 9 (2009), pp. 709-724. Further approaches that potentially result in higher perceptual audio quality with the cost of increased computational load may apply e.g. least-squares optimized mixing to generate the second spatial audio component based on the input audio signals and the spatial audio parameters (also referred to as spatial metadata), e.g. as described in Vilkamo, Juha and Pulkki, Ville, “Minimization of decorrelator artifacts in directional audio coding by covariance domain rendering”, Journal of the Audio Engineering Society 61, no. 9 (2013), pp. 637-646. As a further example, aspects related to providing the output of the spatial processor 328 (and hence the output of the audio processor 302) in Ambisonics format are described e.g. in WO 2018/060550.

In a further example, in case the output format is binaural audio, the focus processor 326 and the spatial processor 328 may further receive (as part of the capture control data and/or the post-capture control data) an indication of (current) head orientation and apply this information together with the indicated focus direction for selection of the HRTFs for generation of the first and second spatial audio components. In this regard, the focus direction applied by the focus processor 326 and the spatial processor 328 is modified in view of the indicated head orientation: as an example in this regard, if the indicated focus direction is the front direction (e.g. 0 degrees) and the indicated head orientation is 30 degrees left (e.g. −30 degrees), HRTFs assigned for the spatial direction at −30 degrees are selected for the respective processing in the focus processor 326 and the spatial processor 328.

As described in the foregoing, the combiner 330 is arranged to combine the first and second spatial audio components to from the focused (spatial) audio signal in accordance with the indicated focus amount. In this regard, the combiner 330 may be arranged to carry out the combination in each frequency-band at each channel of the focused audio signal. In each frequency sub-band in each channel, the combination may be carried out as a linear combination of the respective signals that represent the time-frequency tiles of the first and second spatial audio components in accordance with the focus amount. As an example in this regard, assuming that the focus amount is indicated by a parameter a that has value in the range from 0 to 1, the linear combination may be provided e.g. as a weighted sum of the respective signals from the first and second spatial audio components such that the signal from the first spatial audio component is multiplied by a and the signal from the second spatial audio component is multiplied by (1-a) before summing the signals.

As described in the foregoing, the inverse filter bank 332 is arranged to transform each frame of the focused audio signal (obtained from the combiner 330) from the transform domain back to the time domain for provision to the (optional) audio encoder 334.

As described in the foregoing, the audio processor 302 may optionally include the audio encoder 334 that is arranged to encode the focused and/or spatially processed audio signal output from the inverse filter bank 332 for local storage and/or for transfer to another device. In this regard, any audio encoding technique known in the art that is suitable for encoding multi-channel audio signals may be applied. A non-limiting example in this regard is advanced audio coding (AAC) encoder. In case the audio encoder 334 is not employed as part of the audio processor 302, the focused audio signal may be provided e.g. as a PCM signal.

In a scenario where the audio processor 302 is applied (as part of) the audio processor 102 of the capture arrangement 200a, the spatial audio parameters derived by the spatial analyzer 324 may be provided for the audio formatter 206 for storage in the storage 208 as spatial metadata associated with the intermediate audio data. When accessing the data in the storage, the audio preprocessor 212 may obtain the spatial metadata from the storage 208 together with the intermediate audio data and provide the spatial metadata along with the intermediate audio data for the audio processor 302 applied (as part of) the audio processor 202 in the post-capture arrangement 200b. Consequently, the audio processor 302 in the post-capture arrangement 200b may omit the processing described in the foregoing for the spatial analyzer 324 and directly apply the spatial audio parameters received as the spatial metadata received along with the intermediate audio.

In a variation of the audio processing arrangement 200, the audio formatter 206 is communicatively coupled (e.g. via a communication network) to a server that is arranged to provide audio enhancement processing for the two or more microphone signals obtained at the capture arrangement 200a to derive respective two or more enhanced microphone signals, which may serve (instead of the two or more microphone signals as originally received) as basis for deriving the intermediate audio data in the audio formatter 206 for writing into the storage 208. The purpose of such audio enhancement processing by the server is to provide the two or more modified enhanced microphone signals at higher (perceptual) audio quality, thereby enabling creation of a higher-quality post-captured audio signal via operation of the post-capture arrangement 200b. The server may be provided as a single server device (e.g. a computer) or as a combination of two or more server devices (e.g. computers) that may be arranged to provide, for example, a cloud computing service.

As an example of audio enhancement processing available at the server, the server may be arranged to provide a trained deep leaning network, for example a generative adversarial network (GAN) for improving the signal-to-noise ratio (SNR) of the two or more microphone signals and/or otherwise improve the (perceptual) audio quality of the two or more microphone signals.

As another example of audio enhancement processing available in the server, alternatively or additionally, the server may be arranged to carry out some or all of the predefined audio processing functions assigned to the audio formatter 206 on behalf of the audio formatter 206. As an example, the audio formatter may provide the two or more microphone signals to the server, which carries out e.g. audio encoding (and/or one or more other predefined audio processing function(s)) based on the original two or more microphone signals (or based on the two or more enhanced microphone signals) and provides the audio data resulting from this procedure to the audio formatter 206, which writes this information as the intermediate audio data to the storage 208.

In another (or further) variation of the audio processing arrangement 200, an entity of the post-capture arrangement 200b, e.g. the control data combiner 210 and/or the audio preprocessor 212, may be communicatively coupled (e.g. via a communication network) to the server, which is (further) arranged to analyze the intermediate audio data obtained via the storage 208 or the one or more reconstructed signals derived therefrom by the audio preprocessor 212 and extract, accordingly, a secondary post-capture control data that may be applied to replace or complement the post-capture control data received at the post-capture arrangement 200b. In this regard, a machine learning network in the server may have been trained to identify situations where specific directions of interest exist in the representation of the audio scene conveyed by the intermediate audio data or by the one or more reconstructed signals. As an example, the audio scene may involve a talker on a stage, whereas the machine learning network may derive secondary capture control data that enables controlling audio focus such that it follows the position of person on the stage in the representation of the audio scene. The server may derive and track the position of the talker in the representation of the audio scene via analysis of the intermediate audio data or the one or more reconstructed signals. In a scenario where the captured audio signal is provided together with an associated video signal, derivation and tracking of the talker position may be, additionally or alternatively, based on the associated video signal.

In another variation of the audio processing arrangement 200, one or more of the functionalities described above with references to the server may be carried out by the audio formatter 206 or by the audio preprocessor 212 instead, assuming that the device applied for implementing the respective entity has sufficient processing capacity available thereto.

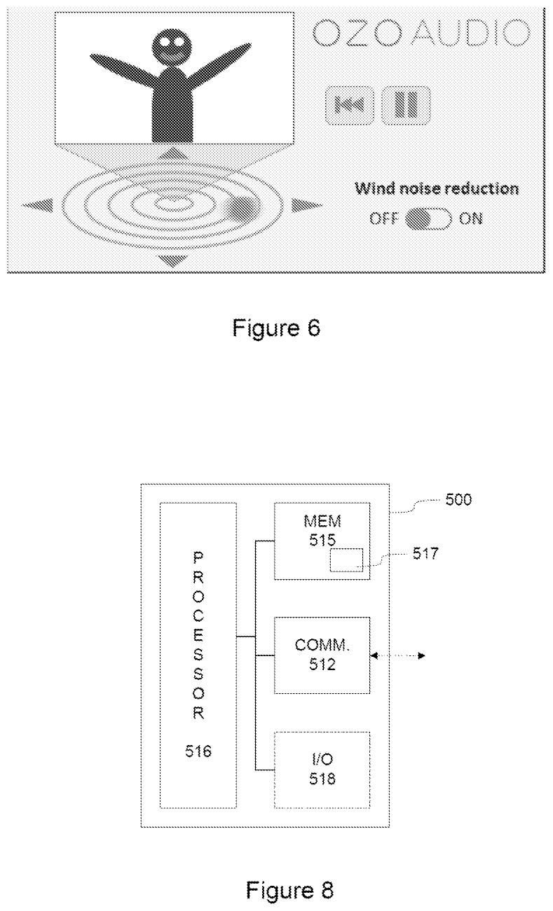

As described in the foregoing, at least some of definitions of the capture control data may originate from user input received upon initiation or during the audio capturing session and/or at least some of definitions of the post-capture control data may originate from user input received upon initiation or during the post-capturing session. As a non-limiting example in this regard, such user input may be received via an user input of the mobile device 150, 150a applied to implement the capture arrangement 200a and/or via an user interface of the (mobile) device 150, 150b applied to implement the post-capture arrangement 200b. In this regard, FIG. 6 depicts an example of an user interface that enables providing user input for controlling application of the audio focusing and/or wind noise reduction in a device 150, 150b that implements the post-capture arrangement 200b. This exemplifying user interface provides visualization of the focus direction, the focus amount and status (on/off) of the wind noise reduction applied in the capturing arrangement 200b (as indicated in the stored capture control data) together with video content captured together with two or more microphone signals. Hence, the user interface of FIG. 6 enables the user to replay the captured video and monitor how the audio focus settings and wind noise reduction controls were adjusted in the underlying capturing session. Therein, the respective capture control definitions may be visualized, for example, as a first marker showing the focus direction as the angle from the center point of a circle illustrated in the user interface and showing the focus amount as the distance from the center point of the circle and by a second marker that illustrates the status (on/off) of the wind noise reduction via its position in the user interface (e.g. such that a first predefined position indicates the wind noise reduction being disabled and a second predefined position indicates the wind noise reduction being enabled). The user playing back the audio and video via the user interface may constitute the post-capturing session, during which the user may adjust position of the first marker with respect to the center point of the circle to change the focus direction and/or the focus accordingly and/or adjust the position of the second marker to change status (on/off) of the wind noise reduction accordingly. Consequently, the user adjusting the position of the first and/or second markers in the user interface are translated into respective definitions of the post-capture control data, which in turn results in operating the audio processor 202 to modify audio characteristics of the currently played back audio signal (i.e. the post-captured audio signal) accordingly.

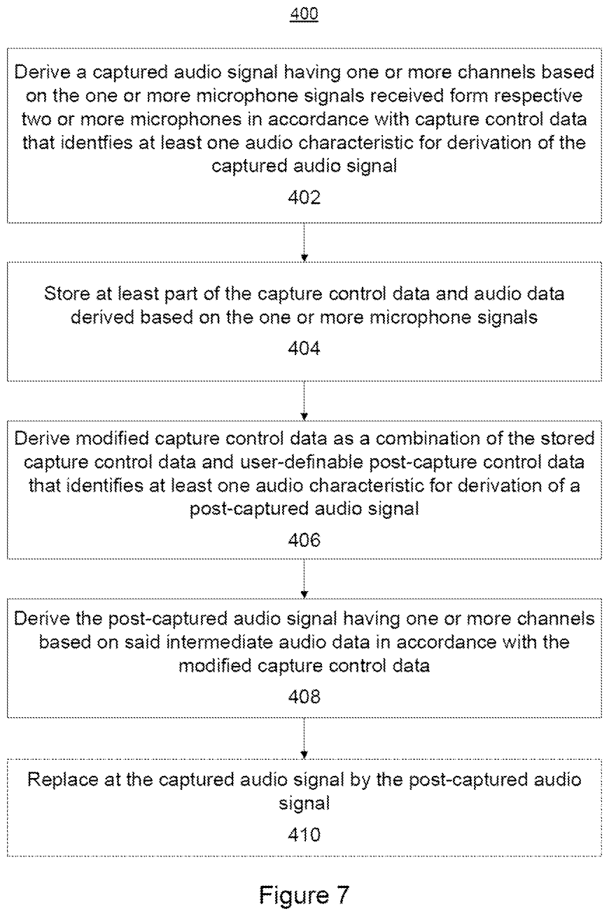

The functionality described in the foregoing with references to components of the capture arrangement 200a and the post-capture arrangement 200b, for example, in accordance with a method 400 illustrated by a flowchart depicted in FIG. 7. The method 400 may be provided e.g. by an apparatus arranged implement the capture arrangement 200a and the post-capture arrangement 200b described in the foregoing via a number of examples, e.g. by the mobile device 150.

The method 400 comprises deriving a captured audio signal based on the two or more microphone signals received form respective one or more microphones in accordance with the capture control data that identifies at least one audio characteristic for derivation of the captured audio signal, as indicated in block 402. The method 400 further comprises storing at least part of the capture control data and intermediate audio data derived based on the two or more received microphone signals, as indicated in block 404. The method 400 further comprises deriving modified capture control data as a combination of the stored capture control data and user-definable post-capture control data that identifies at least one audio characteristic for derivation of a post-captured audio signal, as indicated in block 406. The method 400 further comprises deriving the post-captured audio signal based on said intermediate audio data in accordance with the modified capture control data, as indicated in block 408. The method 400 optionally further comprises replacing the captured audio signal by the post-captured audio signal, as indicated in block 410.

The method 400 may be varied in a plurality of ways, for example in accordance with examples pertaining to respective functionality of components of the audio processing arrangement 200 provided in the foregoing and in the following.

FIG. 8 illustrates a block diagram of some components of an exemplifying apparatus 500. The apparatus 500 may comprise further components, elements or portions that are not depicted in FIG. 8. The apparatus 500 may be employed e.g. in implementing one or more components described in the foregoing in context of the capture arrangement 200a and/or the post-capture arrangement 200b.

The apparatus 500 comprises a processor 516 and a memory 515 for storing data and computer program code 517. The memory 515 and a portion of the computer program code 517 stored therein may be further arranged to, with the processor 516, to implement at least some of the operations, procedures and/or functions described in the foregoing in context of the capture arrangement 200a and/or the post-capture arrangement 200b.

The apparatus 500 comprises a communication portion 512 for communication with other devices. The communication portion 512 comprises at least one communication apparatus that enables wired or wireless communication with other apparatuses. A communication apparatus of the communication portion 512 may also be referred to as a respective communication means.

The apparatus 500 may further comprise user I/O (input/output) components 518 that may be arranged, possibly together with the processor 516 and a portion of the computer program code 517, to provide a user interface for receiving input from a user of the apparatus 500 and/or providing output to the user of the apparatus 500 to control at least some aspects of operation of the capture arrangement 200a and/or the post-capture arrangement 200b implemented by the apparatus 500. The user I/O components 518 may comprise hardware components such as a display, a touchscreen, a touchpad, a mouse, a keyboard, and/or an arrangement of one or more keys or buttons, etc. The user I/O components 518 may be also referred to as peripherals. The processor 516 may be arranged to control operation of the apparatus 500 e.g. in accordance with a portion of the computer program code 517 and possibly further in accordance with the user input received via the user I/O components 518 and/or in accordance with information received via the communication portion 512.

Although the processor 516 is depicted as a single component, it may be implemented as one or more separate processing components. Similarly, although the memory 515 is depicted as a single component, it may be implemented as one or more separate components, some or all of which may be integrated/removable and/or may provide permanent/semi-permanent/dynamic/cached storage.

The computer program code 517 stored in the memory 515, may comprise computer-executable instructions that control one or more aspects of operation of the apparatus 500 when loaded into the processor 516. As an example, the computer-executable instructions may be provided as one or more sequences of one or more instructions. The processor 516 is able to load and execute the computer program code 517 by reading the one or more sequences of one or more instructions included therein from the memory 515. The one or more sequences of one or more instructions may be configured to, when executed by the processor 516, cause the apparatus 500 to carry out at least some of the operations, procedures and/or functions described in the foregoing in context of the capture arrangement 200a and/or the post-capture arrangement 200b.

Hence, the apparatus 500 may comprise at least one processor 516 and at least one memory 515 including the computer program code 517 for one or more programs, the at least one memory 515 and the computer program code 517 configured to, with the at least one processor 516, cause the apparatus 500 to perform at least some of the operations, procedures and/or functions described in the foregoing in context of the capture arrangement 200a and/or the post-capture arrangement 200b.

The computer programs stored in the memory 515 may be provided e.g. as a respective computer program product comprising at least one computer-readable non-transitory medium having the computer program code 517 stored thereon, the computer program code, when executed by the apparatus 500, causes the apparatus 500 at least to perform at least some of the operations, procedures and/or functions described in the foregoing in context of the capture arrangement 200a and/or the post-capture arrangement 200b. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

Although functions have been described with reference to certain features, those functions may be performable by other features whether described or not. Although features have been described with reference to certain embodiments, those features may also be present in other embodiments whether described or not.

1. A method for processing two or more microphone signals, the method comprising:
deriving a first captured audio signal having one or more channels based on the two or more microphone signals received from respective two or more microphones in accordance with capture control data that identifies at least one characteristic for derivation of the first captured audio signal;
storing at least part of the capture control data and intermediate audio data derived based on the two or more received microphone signals;
deriving modified capture control data as a combination of the stored capture control data and user-definable post-capture control data that identifies at least one characteristic for derivation of a second captured audio signal; and
deriving the second captured audio signal having one or more channels based on said intermediate audio data in accordance with the modified capture control data.

2. A method according to claim 1, comprising replacing the first captured audio signal with the second captured audio signal.

3. A method according to claim 1, wherein the intermediate audio data comprises one of:
audio information that is different from audio information conveyed by the captured audio signal; or
respective copies of said two or more microphone signals.

4. (canceled)

5. A method according to claim 1, wherein
said intermediate audio data comprises one or more intermediate audio signals, the method further comprising:
encoding the two or more microphone signals into one or more intermediate audio signals;
decoding the one or more intermediate audio signals into one or more reconstructed signals, and
deriving the second captured audio signal based on the one or more reconstructed signals in accordance with the modified capture control data.

6. A method according to claim 1, wherein said stored capture control data comprises a sequence of control data entries, each control data entry identifying one of:
an identification of a general audio characteristic associated with the respective control data entry;
an identification of an audio processing function associated with the respective control data entry; or
an identification of an audio processing function associated with the respective control data entry and one or more audio parameters associated with the audio processing function associated with the respective control data entry.

7. A method according to claim 1, wherein deriving modified capture control data comprises at least one of:
omitting one or more characteristics identified in the stored capture control data;
replacing one or more characteristics identified in the stored capture control data with one or more characteristics identified in the post-capture control data;
modifying one or more characteristics identified in the stored capture control data based on one or more characteristics identified in the post-capture control data; or
complementing the stored capture control data with one or more characteristic identified in the post-capture control data.

8. A method according to claim 1, wherein the identification of the characteristic in respective one of the capture control data and post-capture control data comprises one of:
an identification of a general audio characteristic for derivation of respective one of the first and second captured audio signals; and
an identification of an audio processing function for derivation of respective one of the first and second captured audio signals.

9. A method according to claim 8, wherein the general audio characteristic comprises at least one of: sampling rate; audio sample resolution; or an audio format.

10. A method according to claim 8, wherein the audio processing function comprises at least one of:
audio signal level adjustment;
audio equalization;
dynamic range compression;
wind noise removal;
modification of a representation of an audio scene conveyed by the respective input audio signals; or
audio encoding in accordance with a predefined audio encoding technique.

11. A method according to claim 1, wherein
the capture control data identifies first audio focusing for derivation of the first captured audio signal, the first audio focusing comprising modifying the representation of an audio scene provided the two or more microphone signals by emphasizing the sounds in a first focus direction by a first focus amount with respect to the sounds in other directions; and
the post-capture control data identifies second audio focusing for derivation of the second captured audio signal, the second audio focusing comprising modifying the representation of an audio scene provided by one or more reconstructed signals derived based on the intermediate audio data by emphasizing the sounds in a second focus direction by a second focus amount with respect to the sounds in other directions.

12. A method for processing two or more microphone signals, the method comprising:
deriving a first captured audio signal having one or more channels based on the two or more microphone signals received from respective two or more microphones in accordance with capture control data that identifies at least one characteristic for derivation of the first captured audio signal; and
storing at least part of the capture control data and intermediate audio data derived based on the two or more received microphone signals to enable derivation of a second captured audio signal having one or more channels based on the intermediate audio data in accordance with at least part of the stored capture control data.

13.-15. (canceled)

16. An apparatus comprising:
at least one processor; and
at least one non-transitory memory including computer program code, which, when executed by the at least one processor, causes the apparatus to:
derive a first captured audio signal having one or more channels based on the two or more microphone signals received from respective two or more microphones in accordance with capture control data that identifies at least one characteristic for derivation of the first captured audio signal;
store at least part of the capture control data and intermediate audio data derived based on the two or more received microphone signals;
derive modified capture control data as a combination of the stored capture control data and user-definable post-capture control data that identified at least one characteristic for derivation of a second captured audio signal; and
derive the second captured audio signal having one or more channels based on said intermediate audio data in accordance with the modified capture control data.

17.-20. (canceled)

21. An apparatus according to claim 16, is further caused to replace the first captured audio signal with the second captured audio signal.

22. An apparatus according to claim 16, wherein the intermediate audio data comprises one of:
audio information that is different from audio information conveyed with the captured audio signal; and
respective copies of said two or more microphone signals.

23. An apparatus according to claim 16, wherein said intermediate audio data comprises one or more intermediate audio signals, the apparatus is caused to:
encode the two or more microphone signals into one or more intermediate audio signals;
decode the one or more intermediate audio signals into one or more reconstructed signals; and
derive the second captured audio signal based on the one or more reconstructed signals in accordance with the modified capture control data.

24. An apparatus according to claim 16, wherein said stored capture control data comprises a sequence of control data entries, each control data entry causes the apparatus to identify one of:
an identification of a general audio characteristic associated with the respective control data entry;
an identification of an audio processing function associated with the respective control data entry; or
an identification of an audio processing function associated with the respective control data entry and one or more audio parameters associated with the audio processing function associated with the respective control data entry.

25. An apparatus according to claim 16, wherein the derived modified capture control data further causes the apparatus to at least one of:
omit one or more characteristics identified in the stored capture control data;
replace one or more characteristics identified in the stored capture control data with one or more characteristics identified in the post-capture control data;
modify one or more characteristics identified in the stored capture control data based on one or more characteristics identified in the post-capture control data; or
complement the stored capture control data with one or more characteristic identified in the post-capture control data.

26. An apparatus according to claim 16, wherein the identification of the characteristic in respective one of the capture control data and post-capture control data causes the apparatus to one of:
identify a general audio characteristic for derivation of respective one of the first and second captured audio signals; and
identify an audio processing function for derivation of respective one of the first and second captured audio signals.

27. An apparatus according to claim 16, wherein
the capture control data identifies first audio focusing for derivation of the first captured audio signal, the first audio focusing causes the apparatus to modify the representation of an audio scene based on the two or more microphone signals with emphasizing the sounds in a first focus direction with a first focus amount with respect to the sounds in other directions; and
the post-capture control data identifies second audio focusing for derivation of the second captured audio signal, the second audio focusing causes the apparatus to modify the representation of an audio scene provided with one or more reconstructed signals derived based on the intermediate audio data with emphasizing the sounds in a second focus direction with a second focus amount with respect to the sounds in other directions.

28. An apparatus comprising:
at least one processor; and
at least one non-transitory memory including computer program code, which, when executed by the at least one processor, causes the apparatus to:
derive a first captured audio signal having one or more channels based on the two or more microphone signals received from respective two or more microphones in accordance with capture control data that identifies at least one characteristic for derivation of the first captured audio signal; and
store at least part of the capture control data and intermediate audio data derived based on the two or more received microphone signals to enable derivation of a second captured audio signal having one or more channels based on the intermediate audio data in accordance with at least part of the stored capture control data.
